(19) United States
(12) Patent Application Publication
(10) Pub. No.: US 2023/0285216 A1
(43) Pub. Date: Sep. 14, 2023

(54) REHABILITATIVE WRIST TRAINING DEVICE FOR USE BY STROKE PATIENTS

(71) Applicant: Mirrored Motion Works, Inc., Cary, NC (US)

(72) Inventors: Donald J. Weisz, Cary, NC (US); Preeti Raghavan, Brooklyn, NY (US); Frank Speranza, Warminster, PA (US)

(21) Appl. No.: 18/119,540

(22) Filed: Mar. 9, 2023

Related U.S. Application Data
(60) Provisional application No. 63/318,185, filed on Mar. 9, 2022.

(51) Int. Cl. A61H 1/02

(52) U.S. Cl. CPC A61H 1/0285

(57) ABSTRACT

A convertible wrist rehabilitative training device for use with a stroke patient includes a base; a first adjustable wrist support that is configured to move between a first handle position for use in wrist flexion and extension training and a second handle position for use in ulnar deviation and radial deviation training; and a second adjustable wrist support that is configured to move between a first handle position for use in wrist flexion and extension training and a second handle position for use in ulnar deviation and radial deviation training. In addition, the device includes means for operatively coupling the first adjustable wrist support with the second adjustable wrist support such that motion of one of the first adjustable wrist support and the second adjustable wrist support as a result of movement of an unaffected wrist on an unaffected hand by the user causes the other of the first adjustable wrist support and the second adjustable wrist support and an affected wrist on an affected hand to move in a symmetrical motion.

### CROSS REFERENCE TO RELATED APPLICATION

The present application claims priority to and the benefit of U.S. patent application No. 63/318,185, filed Mar. 9, 2022, which is hereby incorporated by reference in its entirety.

### TECHNICAL FIELD

The present invention relates to rehabilitative devices and in particular, the present invention relates to wrist rehabilitative devices that are configured to use the motion of an unaffected (or less affected) body part to “train” the affected body part and thereby incorporate the brain motor system in the rehabilitation process.

### BACKGROUND

While technology continues to make rapid advancements in the medical field, there are still a number of diseases and ailments that strike a vast number of adults and can lead to death. For example, a stroke is currently one of the leading causes of death in American and is also unfortunately one of the leading causes of adult disability. A stroke, which also referred to as a “brain attack,” occurs when a blood clot blocks an artery (a blood vessel that carries blood from the heart to the body) or a blood vessel (a conduit through which blood moves throughout the body) ruptures and thereby interrupts blood flow an area of the brain. When either of these events occurs, brain cells begin to die and brain damage occurs.

As a result of the interruption in blood flow and brain cells dying during a stroke, the affected area of the brain is unable to function and abilities controlled by that area of the brain are lost. These abilities include but are not limited to movement (ability to move one or more limbs on one side of the body), speech (ability to understand or formulate speech), memory, and sight (ability to see one side of the visual field). How a stroke patient is affected depends on where the stroke occurs in the brain and how much of the brain is damaged. For example, an individual who has a small stroke may experience only minor problems such as weakness of an arm or leg. Individuals who have larger strokes may be paralyzed on one side or lose their ability to speak. Some people recover completely from strokes, but more than ⅔ of survivors will have some type of disability for the rest of their lives. More specifically, many survivors suffer from residual neurological deficits that persistently impair function. In particular, dysfunction from upper extremity (UE) hemiparesis impairs performance of many daily activities such as dressing, bathing, self-care, and writing and as a result, functional independence is greatly reduced. In fact, studies show that only 5% of adults regain full arm function after stroke and unfortunately, 20% regain no functional use.

For a person that survives a stroke, the person will most likely undergo stroke rehabilitation which is the process by which patients with disabling strokes undergo treatment to help the patients return to a normal life as much as possible by regaining and relearning the skills of everyday living. This can be a very long and difficult process and therefore is very challenging and difficult for the patient and all loved ones. As a result, stroke rehabilitation also aims to help the survivor understand and adapt to the difficulties ahead, prevent secondary complications and educate family members to play a supporting role and assist the survivor as much as possible and where needed.

Depending upon the severity of the stroke, the rehabilitation program will vary and thus the makeup of the rehabilitation team will also vary. In any event, a rehabilitation team is usually multidisciplinary since it involves staff with different skills that are all working together to help the patient recover and relearn and develop old skills and abilities. The rehabilitation staff can include but is not limited to nursing staff, physiotherapy, occupational therapy, speech and language therapy, and usually a physician trained in rehabilitation medicine. Other rehabilitation programs will include assist from psychologists, social workers, and pharmacists since unfortunately, a large number of patients manifest post-stroke depression, and other social problems related to their disability. However, most stroke patients undergo physical therapy (PT) and occupational therapy (OT) and therefore, these are considered cornerstones of the rehabilitation process. During the rehabilitative process, assistive technology, such as a wheelchair, walkers, canes and orthosis are commonly used to assist the patient and to compensate for impairments. Speech and language therapy is provided for patients with problems understanding speech or written words, problems forming speech and problems with swallowing. While PT and OT have overlapping areas of working, their main attention fields are different in that PT involves re-learning functions such as transferring, walking and other gross motor functions. In contrast, OT focuses on exercises and training to help relearn everyday activities known as the activities of daily independent living, such as eating, drinking, dressing, bathing, cooking, reading and writing, and toileting, etc.

It is generally accepted in the medical community that there is an important treatment window for beginning the rehabilitative process. Traditionally, methods of stroke rehabilitation have been focused on the first three months after stroke and consist largely of passive (nonspecific) movement approaches or compensatory training of the nonparetic arm. This time window is in part based on and consistent with natural history studies of stroke recovery that show a plateau after three months, although it has been demonstrated that recovery can occur well beyond this window into the late chronic phase several years post-stroke. Features of the motor impairment are however different in the period immediately after stroke (i.e., the first 3 months or so) and in the later post-stroke period (after 3 months). In the beginning there is predominantly weakness, but later muscular overactivity develops in certain muscle groups that leads to abnormal posturing and masks strength gains in the non-overactive muscle groups.

Much of the therapy provided by PTs and OTs in the first 3 months is hands-on and is spent in passively maintaining range-of-motion in the joints of the affected side so as to prevent deformity and in teaching compensatory strategies to preserve functional independence to the extent possible using the unaffected limb, assistive devices and the like. Little time and effort is expended in trying to restore muscle activation/strength in the paralyzed affected limb. With respect to rehabilitative treatment for people suffering with chronic hemiparetic arm dysfunction, there are a number of new devices for upper arm rehabilitation and training. Most of these devices concentrate on the affected arm and use mechanical devices/robotics and electrical stimulation to controllably move the affected arm. For example, there are robotic devices that facilitate movement of the targeted muscle group or groups by using a robot to sense and then stimulate appropriately if the patient is not able to complete the intended movement. These new rehabilitation devices were introduced to allow increased amounts of ‘practice’ to train the affected limb while reducing the burden on the therapist. However, these devices are overly complex, expensive (since they use computers (virtuals) and robotics), and “train” the affected limb by producing passive movements in one or more joints using an external source of energy. The complexity and costs of these devices prevent them from being used in a number of settings, including a home or remote clinic that does not have sufficient resources for purchase of expensive equipment, etc.

A number of recent studies have shown that recovery is an “active” rather than a “passive” process where it is the brain that needs to be trained in conjunction with movements of the limb. Over the last few decades, it has been shown that there is a complex interaction between the two sides of the brain in the control of movement of one limb. Both sides of the brain contribute to the control of each limb, but one side is usually “inhibited” in a healthy individual. However, this inhibition is removed when one side is damaged, and as a result the undamaged side of the brain may play a greater role in the recovery of the affected limb. Existing rehabilitation devices are not focused on harnessing the already available brain activity from the unaffected side to train affected arm movements.

Therefore, there is a need for alternative forms of rehabilitative devices that can be used in more settings such as the ones mentioned above and can be offered in a more cost effective manner and in a more user friendly (less complex) manner.

### SUMMARY

In accordance with the present invention, a wrist rehabilitative device intended for use by stroke patients is provided that are specifically configured to harness brain activity from the unaffected side to “train” affected arm movements by using the motion of the unaffected (or less affected) limb. Using the healthy limb to train the affected limb is known as “mirroring.” Although the brain control of the muscular system is almost entirely contralateral, there is approximately a 10% contribution of the ipsilateral brain to individual muscles. By using the unaffected brain to move both body parts (limbs) in the same manner, the recovery from stroke is facilitated by increasing control of the muscles by the ipsilateral brain.

According to one embodiment, a rehabilitative training device for use with a stroke patient includes a first component that is operatively coupled to a first body part (unaffected body part) of the patient and a second component that is operatively coupled to a second body part (affected body part) of the patient. The first component and second component are operatively coupled to one another such that motion of the first component as a result of movement of the first body part by the user causes the second component and second body part to move in a symmetrical motion.

The device described herein also enables patients to conduct range-of-motion therapy within their own homes. Restricted range of motion, which typically occurs after a stroke, can cause pain, impair function, and increase the risk of skin breakdown leading to open sores. In order to reduce these complications of stroke, range-of-motion exercises are prescribed for almost all patients. The inexpensive device described herein can be used to supplement range-of-motion therapy that patients initially receive in hospital or other therapeutic settings when still covered by insurance, but more importantly enable them to continue this important therapy at home long after insurance no longer covers it.

In one embodiment, a convertible wrist rehabilitative training device for use with a stroke patient includes a base; a first adjustable wrist support that is configured to move between a first handle position for use in wrist flexion and extension training and a second handle position for use in ulnar deviation and radial deviation training; and a second adjustable wrist support that is configured to move between a first handle position for use in wrist flexion and extension training and a second handle position for use in ulnar deviation and radial deviation training. In addition, the device includes means for operatively coupling the first adjustable wrist support with the second adjustable wrist support such that motion of one of the first adjustable wrist support and the second adjustable wrist support as a result of movement of an unaffected wrist on an unaffected hand by the user causes the other of the first adjustable wrist support and the second adjustable wrist support and an affected wrist on an affected hand to move in a symmetrical motion.

These and other aspects, features and advantages shall be apparent from the accompanying Drawings and description of certain embodiments of the invention.

### BRIEF DESCRIPTION OF THE DRAWINGS

FIG. 1 is a perspective view of one exemplary wrist training device according to one embodiment;

FIG. 2 is a top plan view of a table top of the device;

FIG. 3 is a perspective view of a first slide pivot assembly;

FIG. 4 is a top plane view of a wrist pivot support of the assembly of FIG. 3;

FIG. 5 is side elevation view thereof;

FIG. 6 is a perspective view of a sub-assembly of the assembly of FIG. 3;

FIG. 7 is a side elevation view of a handle slide;

FIG. 8 is a front elevation view of a handle mount;

FIGS. 9 and 10 illustrate handle parts that form of handle when assembled;

FIG. 11 is a perspective view of the handle mount;

FIG. 12 is a side elevation view thereof;

FIG. 13 is a perspective view of a fastener;

FIG. 14 shows a clamp nut;

FIG. 15 is a perspective view of a second slide pivot assembly;

FIG. 16 is a perspective view of a sub-assembly of the assembly of FIG. 15;

FIG. 17 is a perspective view of a handle bracket;

FIG. 18 is a perspective view of a first forearm support member;

FIG. 19 is a perspective view of a bracket of the first forearm support member;

FIG. 20 is a perspective view of a second forearm support member;

FIG. 21 is a perspective view of a bracket of the second forearm support member;

FIG. 22 is a top plan view of a left ruler;

FIG. 23 is a top plan view of a right ruler;

FIG. 24 is a side view of a stop pin for attachment to the table top;

FIG. 25 is a perspective view of a handle plate accessory;

FIG. 26 is a side elevation view thereof;

FIG. 27 is a schematic showing one exemplary drive mechanism; and

FIG. 28 is a side perspective view of a two pulley and two cable drive mechanism shown in FIG. 27.

### DETAILED DESCRIPTION OF CERTAIN EMBODIMENTS OF THE INVENTION

In accordance with the present invention, a number of rehabilitative devices intended for use by stroke patients are provided that are specifically configured to harness brain activity from the unaffected side to “train” affected arm movements by using the motion of the unaffected (or less affected) limb to “train” symmetrical motions of the affected one. Using the healthy limb to train the affected limb is known as “mirroring.” Although the brain control of the muscular system is almost entirely contralateral, there is approximately a 10% contribution of the ipsilateral brain to individual muscles. By using the unaffected brain to move both body parts (limbs) in the same manner, the recovery from stroke is facilitated by increasing control of the muscles by the ipsilateral brain.

The devices described herein also enable patients to conduct range-of-motion therapy within their own homes. Restricted range of motion, which typically occurs after a stroke, can cause pain, impair function, and increase the risk of skin breakdown leading to open sores. In order to reduce these complications of stroke, range-of-motion exercises are prescribed for almost all patients. The inexpensive devices described herein could be used to supplement range-of-motion therapy that patients initially receive in hospital or other therapeutic settings when still covered by insurance, but more importantly enable them to continue this important therapy at home long after insurance no longer covers it.

The devices, indicated by the headings below, are all based on one body part “training” the other and the active use of the patient's brain motor system to facilitate the rehabilitation.

### Wrist Trainer

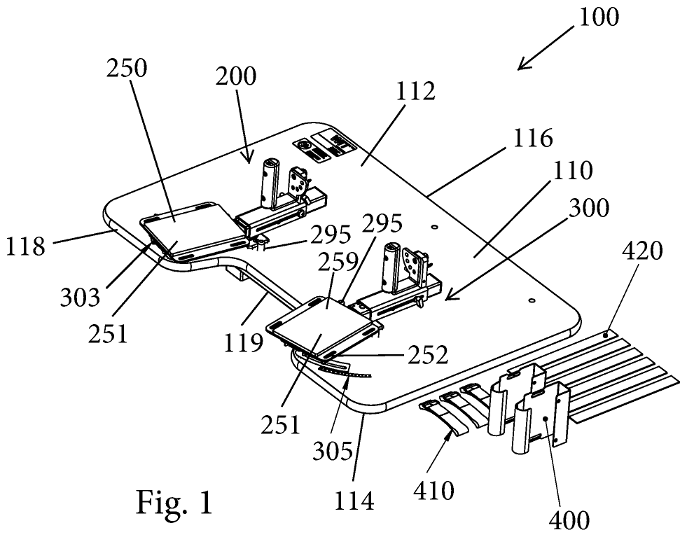

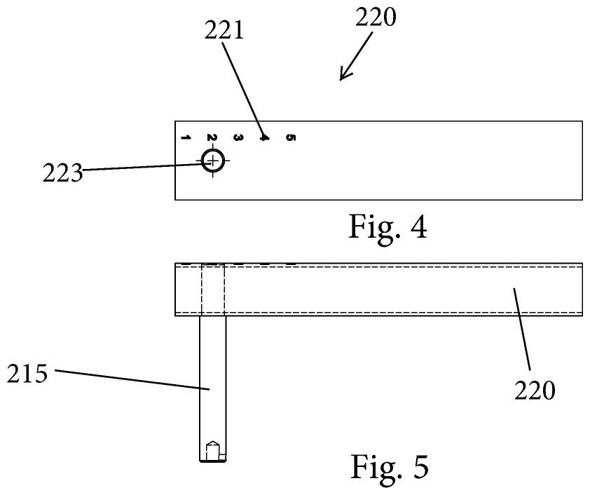

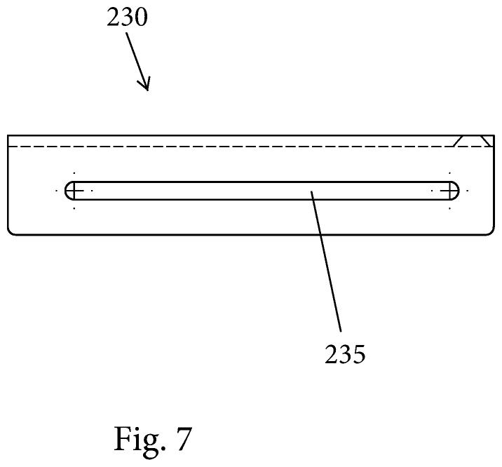

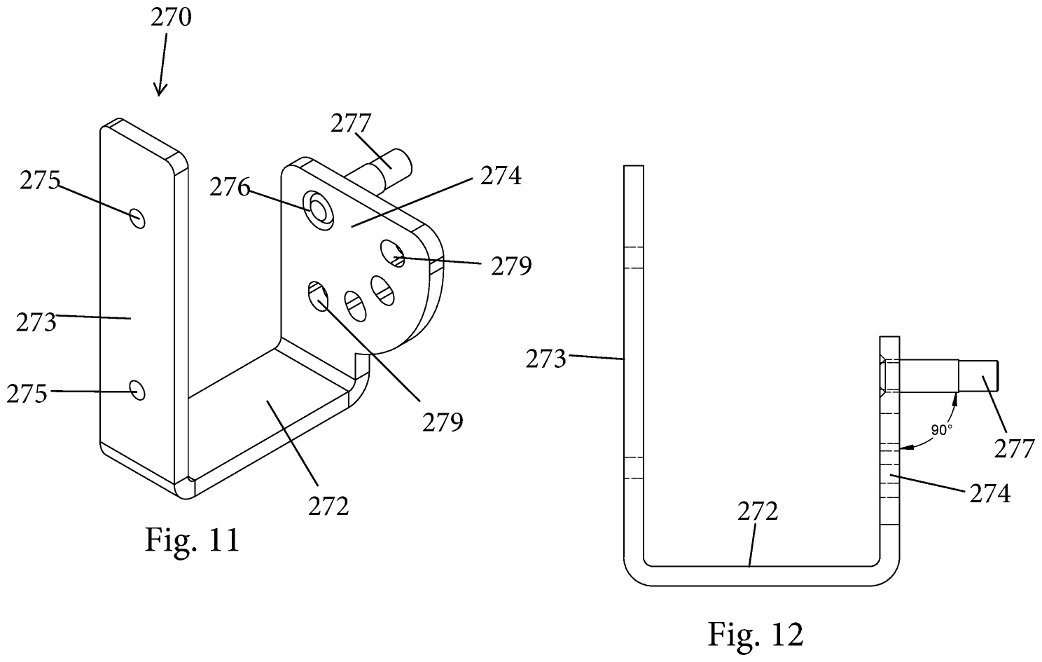

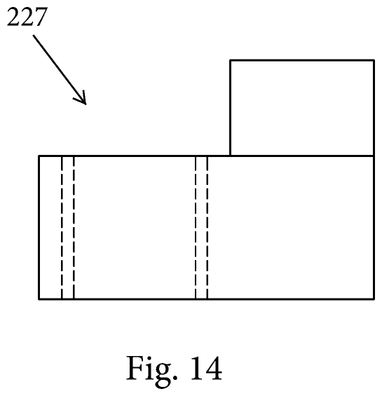

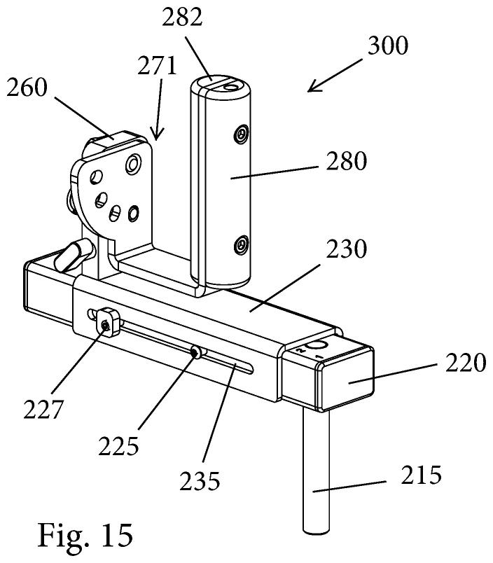

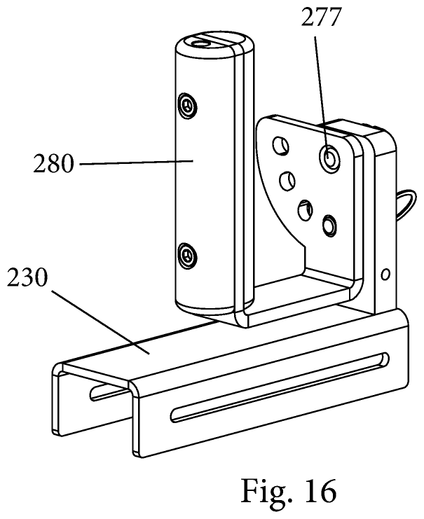

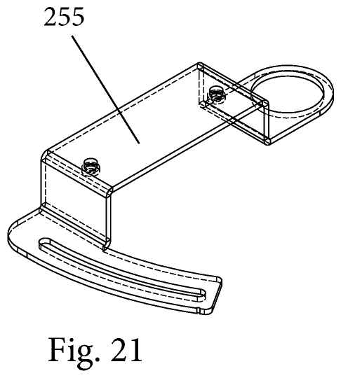

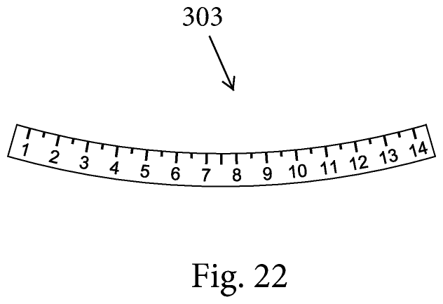

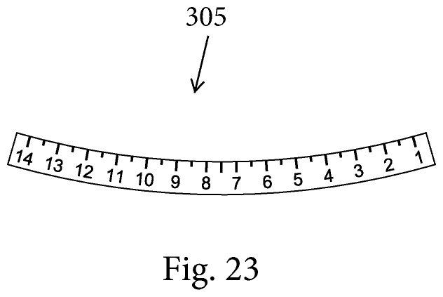

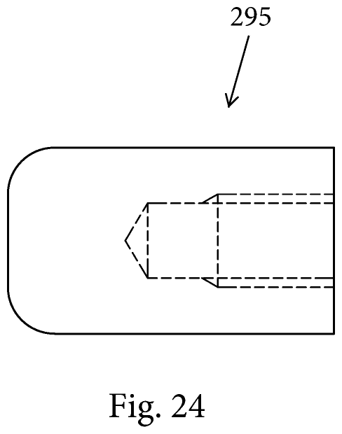

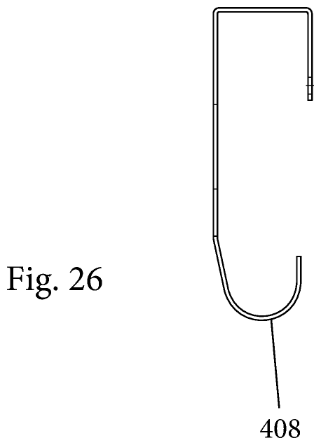

Now referring to FIGS. 1-28, a wrist trainer 100 is shown. The wrist trainer 100 enables a stroke patient to use his/her unaffected wrist (and unaffected brain) to facilitate substantially symmetrical movements with the affected wrist. The underlying principle, as discussed hereinbefore, is that rehabilitation of an affected wrist can be facilitated by increasing the participation of the brain's intact motor systems in causing the affected wrist to move.

Before describing the wrist trainer 100, certain terms used herein are discussed below.

Wrist Flexion and Extension

Wrist flexion is the action of bending your hand down at the wrist, so that your palm faces in toward your arm. It's part of the normal range of motion of your wrist. When your wrist flexion is normal, that means that the muscles, bones, and tendons that make up your wrist are working as they should. Flexion is the opposite of extension, which is moving your hand backward, so that your palm is facing up. Extension is also part of normal wrist range of motion.

If a person does not have normal wrist flexion or extension, the person will have trouble with daily tasks involving wrist and hand use.

Ulnar Deviation and Radial Deviation

Ulnar deviation, otherwise known as ulnar flexion, is the movement of bending the wrist to the little finger, or ulnar bone, side. Radial deviation, otherwise known as radial flexion, is the movement of bending the wrist to the thumb, or radial bone, side.

Neutral Position

The neutral position of the wrist, is that position where the wrist is in straight alignment with the forearm: no flexion, extension, radial or ulnar deviation. The wrist is at the mid-point between supination and pronation.

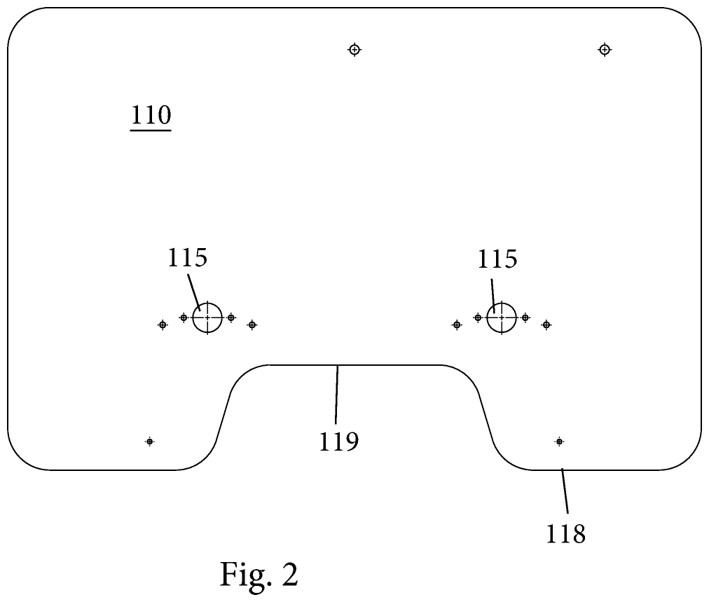

The wrist trainer 100 is configured to not only enable alternating wrist flexion and extension but also enables alternating ulnar deviation and radial deviation. The wrist trainer 100 includes a substrate in the form of a tabletop (table) 110 to which the working components of the wrist trainer 100 are coupled, as described herein. The table 110 can come in different sizes and shapes, with the illustrated table 110 being generally rectangular shaped with a top surface 112, an opposite bottom surface 114, a rear edge 116 and an opposite front edge 118. The front edge 118 can include a cutout or notch 119 to accommodate the body of the patient (user). The table 110 includes a pair of through holes 115 (FIG. 2).

The wrist trainer 100 includes a first slide pivot assembly 200 that is movably coupled to the table 110 and a second slide pivot assembly 300 that is movably coupled to the table 110. The first slide pivot assembly 200 can be considered to be a left slide pivot assembly and the second slide pivot assembly 300 can be considered to be a right slide pivot assembly. Each of these assemblies 200, 300 is described below and since the assemblies 200, 300 include similar or the same parts, like parts are numbered alike.

Forearm Supports

A first forearm support member 250 is provided and together with the assembly 200 define, as described below, a structure on which the forearm and wrist are supported. Some adjustment of the first forearm support member 250 along the table can be provided. The first forearm support member 250 can comprises a structure that has a flat top surface or slightly concave surface and has opposing sides. Along the flat top surface, a pad 251 (e.g., foam pad) or the like can be disposed to provide a comfortable surface on which the user's left forearm rests. Along each of the opposing sides, there can be one or more slots 252 that allow securing members, such as straps (e.g., hook and loop straps) to be received for extending across the user's forearm to securely hold the forearm against the first forearm support member 250. In the illustrated embodiment, there are two slots 252 along each side and thus, there are two pairs of opposing slots 252 to allow two securing members to be used to secure the forearm. When the forearm is placed on the first forearm support member 250, the patient's left hand extends forward of the first forearm support member 250 and can grasp the first slide pivot assembly 200. The first slide pivot assembly 200 is thus located forward of the first forearm support member 250.

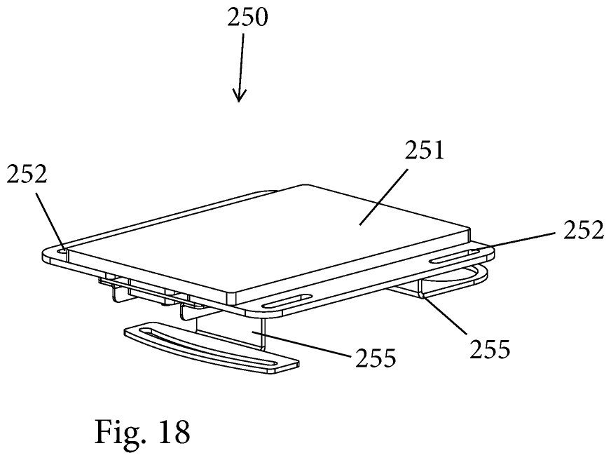

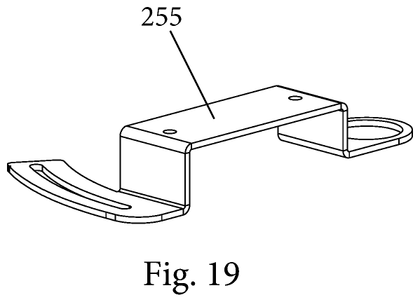

The first forearm support member 250 is elevated relative to the table 110 and can be attached thereto with hardware such as one or more brackets 255 (FIGS. 18 and 19) or the like. As shown, the bracket 255 can be a swivel plate with one or more slots or openings to allow for small adjustments to be made to the position of the forearm support member 250 to the table 110. As mentioned, the circular hole in the bracket 255 accommodates and permits the shaft 115 to pass through the hole 115 in the table 110.

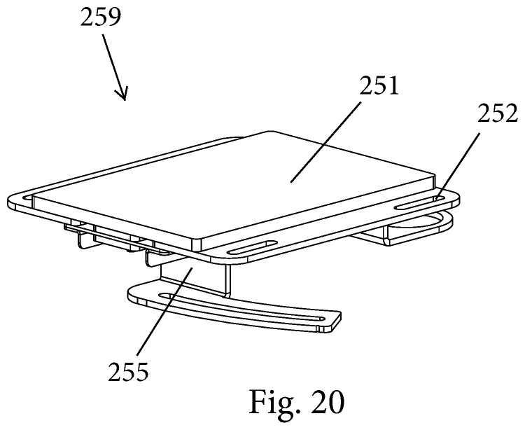

A second forearm support member 259 (FIG. 20) is provided and can be a right support, while the first forearm support member 250 (FIG. 18) is a left support. However, the two members contain essentially the same or similar components and thus, these parts are numbered alike.

First Slide Pivot Assembly (Left)

The first slide pivot assembly 200 is formed of a number of parts that are assembled together.

The first slide pivot assembly 200 pivots relative to the table 110 about a bearing shaft 215. The table 110 is formed such that it includes two through holes 115 which permit passage of the bearing shafts associated with the assemblies 200, 300. As described below, the bearing shaft 215 defines a pivot axis of a drive mechanism that is coupled the first slide pivot assembly 200. The illustrated bearing shaft 215 is an elongated round shaft (and can be tapered as shown). The bearing shaft 215 is fixedly coupled to a wrist pivot support 220. The wrist pivot support 220 is an elongated structure having a first end 222 and an opposite second end 224. The bearing shaft 215 is coupled near the first end 222 as by being received in a tapered hole 223. The other end of the bearing shaft 215 can pass through the circular hole formed in the bracket 255 (FIG. 19) and through the hole 115 in the table 110 to allow a bottom end of the bearing shaft 215 to be disposed and accessible below the table 110. As shown, the elongated structure of the wrist pivot support 220 can have a rectangular or square cross section. The wrist pivot support 220 includes a top surface on which indicia 221 is disposed. The indicia 221 can be in the form of a series of numbers, such as 1 to 5, that are linearly formed from the first end 222 toward the second end 224 in spaced relationship. The indicia 221 define numbered settings of the wrist pivot support 220 as described below. In the illustrated embodiment, the bearing shaft 215 is located adjacent the number 2 and this defines the pivot axis of the assembly.

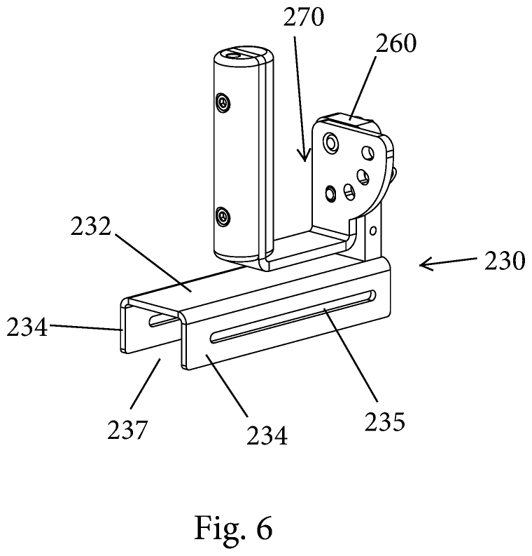

As shown in FIG. 6, the first slide pivot assembly 200 also includes a handle slide (slide housing) 230 that, as illustrated, can have an inverted U-shape. In particular, the handle slide 230 includes a top wall 232 and a pair of opposing side walls 234 that integrally attach to the top wall 232. Each of the side walls 234 includes an elongated slot 235 formed therein. The two slots 235 are opposite one another.

Since the handle slide 230 has an inverted U-shape, it defines a hollow space 237 between the side walls 234 and below the top wall 232. This hollow space 237 is configured to receive the wrist pivot support 220 in a sliding manner in that the handle slide 230 is meant to slide longitudinally along the wrist pivot support 220.

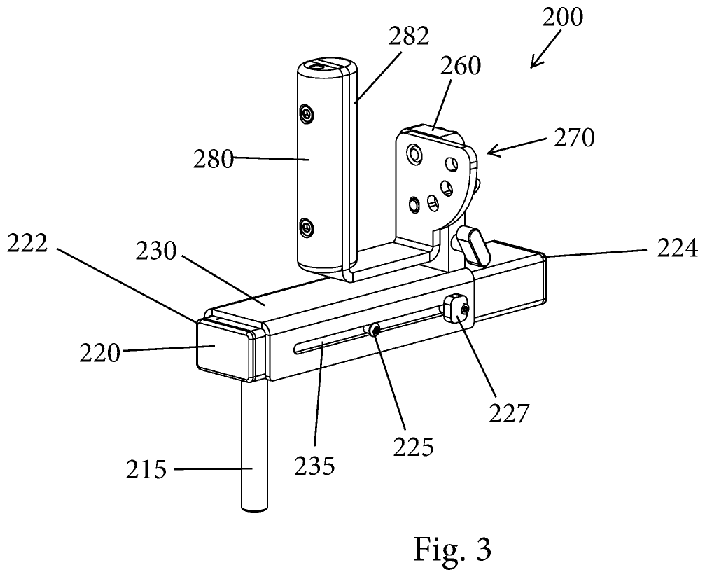

A guide pin 225 (FIG. 3) can be provided to guide the movement of the handle slide 230 relative to the wrist pivot support 220. The guide pin 225 can be located along and be fixedly attached to a side wall of the wrist pivot support 220. The guide pin 225 extends outwardly from the side wall of the wrist pivot support 220 and can be perpendicular thereto. The guide pin 225 is received within the elongated slot 235 and can include an enlarged head that ensures the guide pin 225 does not fall out of the elongated slot 235. A clamp nut 227 (FIG. 3) can be provided to fixedly attach the handle slide 230 to the wrist pivot support 220 at one of a plurality of selection locations. The clamp nut 227 passes through the elongated slot 235 and is tightened to fixedly attach the handle slide 230 to the wrist pivot support 220. The clamp nut 227 can be square shaped. Loosening of the clamp nut 227 allows for longitudinal (axial) movement of the handle slide 230 to the wrist pivot support 220. The clamp nut 227 thus allows quick adjustment.

The indicia 221 is used to indicate to the user the relative positions between the handle slide 230 and the wrist pivot support 220. In particular, the degree of which the first end of the wrist pivot support 220 is visible in front of the first end of the handle slide 230 indicates the relative position between these two parts. When the indicia is numbers 1-5, the higher the number that is visible in front of the handle slide 230, the further the handle slide 230 is away from the first end of the wrist pivot support 220 (i.e., the handle slide 230 is slid along the top surface of the wrist pivot support 220 toward the second end of the wrist pivot support 220).

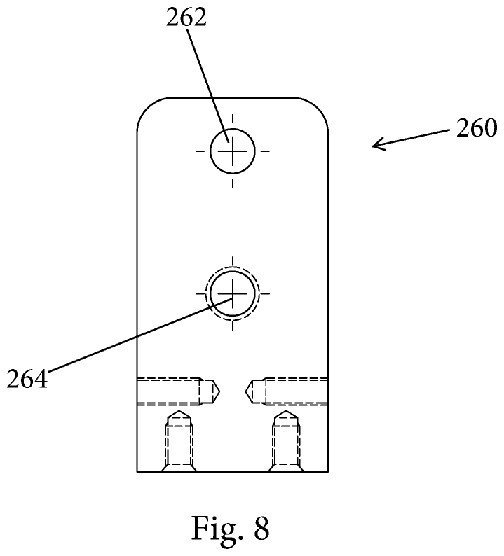

The handle slide 230 also includes a handle assembly that includes a handle mount 260 (FIG. 6) that is fixed to the top surface of the handle slide 230. The handle mount 260 is an upright structure that can be mounted perpendicular to the top surface of the handle slide 230. The handle mount 260 includes a first through hole 262 (FIG. 8) and a second through hole 264 that is located below the first through hole 262. The handle mount 260 includes blind holes formed along at least a bottom edge to permit the handle mount 260 to be mounted to the handle slide 230.

The handle assembly also includes a handle bracket 270 that is configured to be coupled to a rear face of the handle mount 260. The handle bracket 270 is generally U-shaped with legs of different length. More specifically, the handle bracket 270 includes a bottom wall 272, an upright first side wall 273 and an upright second side wall 274 both of which are integrally connected to the bottom wall 272. As shown, the height of the first side wall 272 is greater than the height of the second side wall 274. The first and second side walls 273, 274 are parallel to one another and are spaced apart so as to define a hollow space that receives the fingers of the user as described below.

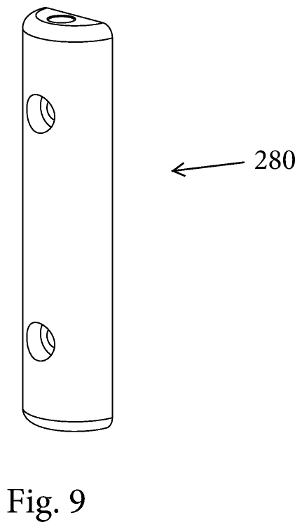

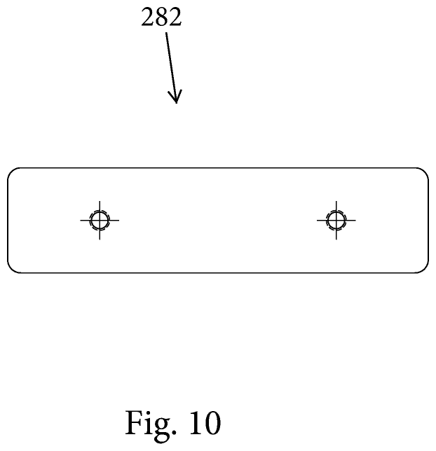

The first side wall 273 has one or more through holes 275. In the illustrated embodiment, there are two through holes 275 spaced apart from one another. The handle itself is defined by a front handle part 280 and a rear handle part 282 (FIGS. 9 and 10). Each of these parts 280, 282 can have a hemispherical shape or partial elliptical shape such that when combined, the two structure define the handle structure that is to be grasped by the user. The parts 280, 282 can be attached to the first side wall 273 using fasteners that pass through holes formed in the parts 280, 282 and through the holes 275.

The second side wall 274 is wedge shaped with a flag portion that extends outwardly from one side edge of the bottom wall 272. The second side wall 274 includes a first hole 276 that receives a pivot shaft 277 that defines a pivot axis for the handle bracket 270. As mentioned, the handle bracket 270 pivots relative to the handle mount 260. The second side wall 274 also includes a series of second holes 279 that are formed along an arcuate path. One second hole 279 is located directly below the first hole 276 (this hole is located at one end of the arcuate path) and another second hole 279 is located adjacent to the first hole 276 (this hole is located at the opposite end of the arcuate path).

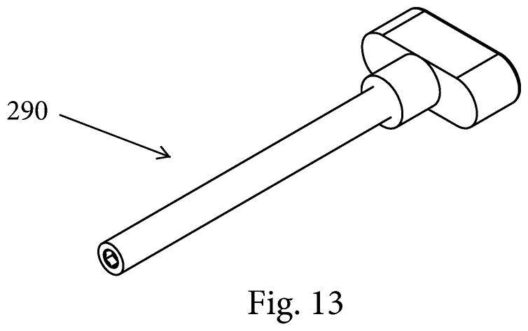

In order to position and lock the handle bracket 270 relative to the handle mount 260, one of the second holes 279 is aligned with the second through hole 264 and a fastener 290 (FIG. 13), such as a thumb screw or lock pin or the like, is used to lock the two parts together. The second holes 279 are formed such that the second hole at one end of the arcuate path, when aligned with the second through hole 264 results in the handle being completely upright and perpendicular to the top surface of the handle slide 230. In contrast, when the handle bracket 270 and handle are rotated such that the second hole at the other end of the arcuate path is aligned with the second through hole 265, the handle is now oriented horizontal (parallel) to the top surface of the handle slide 230. As described below, when wrist extension/flexion training is desired, the handle is placed in the upright perpendicular position and conversely, when ulnar deviation and radial deviation training is desired, the handle is placed in the horizontal position. For patients that are unable to use the device in either of these positions, the handle can be placed into one or more intermediate positions between the upright perpendicular position and the horizontal position as a result of the adjustability of the handle bracket 270 relative to the handle mount 260.

In addition, there can be additional second holes 279 as shown between the two holes at the ends of the arcuate path. These additional second holes 279 can be used to set a wrist angle intermediate between vertical and horizontal wrist positions in patients who have a level of wrist rigidity that prevents them from achieving the optimal positions. The rigidity, as described in the initial background section, can present later during recovery from stroke.

Second Slide Pivot Assembly (Right)

The second slide pivot assembly 300 is very similar to the first slide pivot assembly 200 and is formed of a number of parts that are assembled together. As a result, like parts are numbered alike.

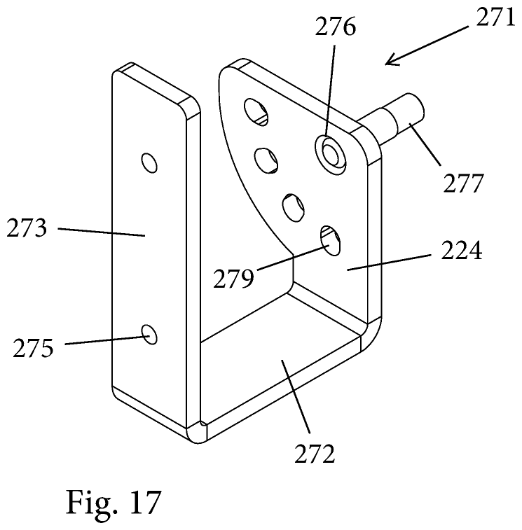

The main difference between the two assemblies is the handle bracket constructions are mirror image of another. The assembly 300 uses a handle bracket 271 (FIG. 17) that is a mirror image of bracket 270.

A pair of stop pins 295 (FIG. 1) can be provided and extend upward from the table 110. These two stop pins 295 limit the degree of pivoting of the assemblies 200, 300 across the table 110. If the assembly 200, 300 pivots into contact with the stop pin 295, its further movement is prevented.

As shown in FIGS. 1, 22 and 23, in addition, a left ruler 303 and a right ruler 305 can be provided along the table 110 to measure the point at which the arm rests are secured laterally. This enables the therapist to position the user's forearms in the same position each time the device is used.

Flat Hand Plate 400

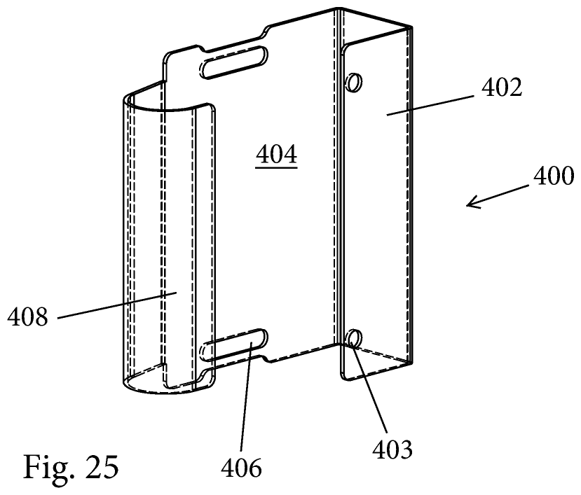

As shown in FIGS. 1 and 25, in the event that the user (patient) is not able to fully grasp the upright handle, a handle plate accessory 400 can be provided. In this case, the handle plate accessory 400 is attached to the handle bracket 270, 271. In particular, the accessory 400 can be mounted to the side wall 273 of the handle bracket. The handle plate accessory 400 includes a first wall 402 that has openings 403 formed therein. These openings 403 can be aligned with through holes 275 to permit mounting of the handle plate accessory 400 to the handle bracket 270, 271. The handle plate accessory 400 also includes a second wall 404 that includes slots 406 that can receive straps 420 (FIG. 1) for securing the patient's hand to the handle plate accessory 400. A third wall 408, such as a curved wall, is also provided and can receive the fingers of the user. In this embodiment, the user does not actively grasp a curved handle (cylindrical or elliptical shaped) but instead, the hand is secured to the plate with the straps 420.

Drive Mechanism

The wrist trainer 100 is constructed such that movement of the first wrist holder (assembly 200) or second wrist holder (assembly 300) is mirrored in the corresponding second wrist holder (assembly 300) or first wrist holder (assembly 200) and therefore movement of the unaffected hand (wrist) is mimicked by an identical or similar movement in the affected hand (wrist). In other words, as a result of the mechanical coupling between first wrist holder (assembly 200) and the second wrist holder (assembly 300), one of the first and second wrist holders (assemblies 200, 300) acts as a driven member since movement thereof is caused by movement of the unaffected hand (wrist) that is supported thereby and the other of the first and second wrist holders (assemblies 200, 300) acts as a slave member since movement (a driving action) in one wrist holder is translated into movement of the other wrist holder.

The mechanical coupling between the first wrist holder (assembly 200) and the second wrist holder (assembly 300) can be accomplished in a number of different ways. For example, one type of mechanical coupling can be in the form of a series of pulleys and cables (cords) that link the first wrist holder (assembly 200) to the second wrist holder (assembly 300) in such a way that the above described desired (mirrored) movements result. For example, if the left wrist is placed in flexion by the user, the right wrist is likewise placed in flexion and similarly, if the user places the left wrist in extension, the drive mechanism causes the right wrist to likewise be placed in extension.

One exemplary type of drive mechanism is disclosed in U.S. Pat. No. 9,549,866, which is hereby incorporated by reference in its entirety.

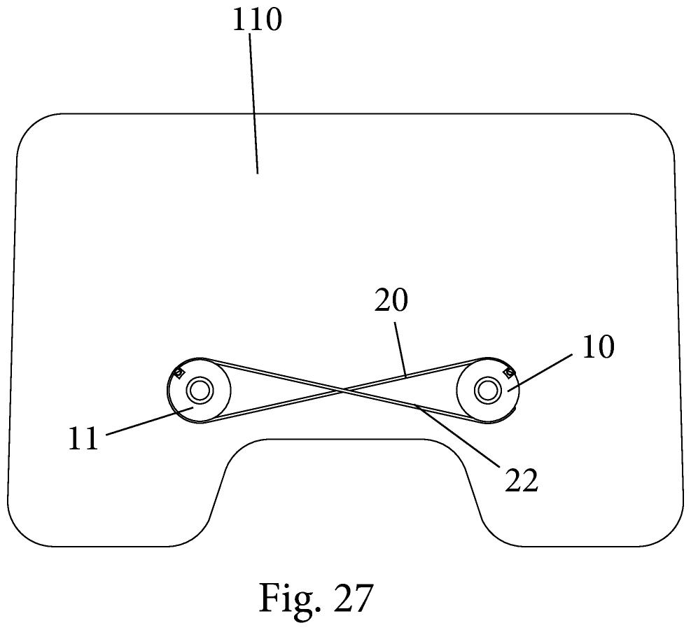

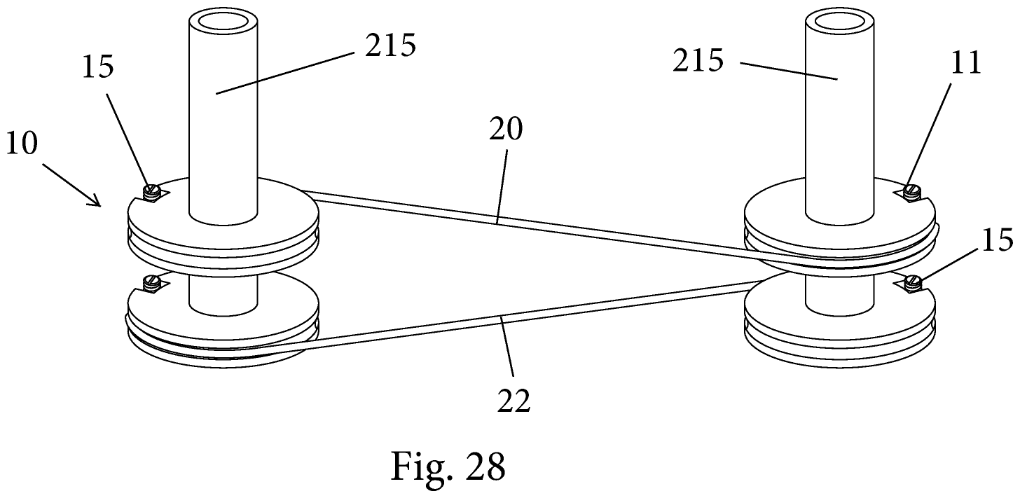

For example, in FIGS. 27 and 28, one drive mechanism is shown. It will be understood the motion of each of the assemblies 200, 300 is of a sweeping (pivoting) nature. As a result, one type of drive mechanism uses pulleys and cables that are connected so that when the left assembly 200 sweeps outward, the right assembly 300 likewise sweeps outward and similarly, when the left assembly 200 sweeps inward, the right assembly 300 sweeps inward. This can be accomplished using pulleys and cables in different ways.

There are different pulley and cable systems that can achieve this action. For example, as shown in FIG. 27, connections can be entirely done below the table as shown. More specifically, a bottom end of the bearing shaft 215 of the first slide pivot assembly 200 includes a first pulley 10 that is fixedly attached thereto so that rotation of the shaft 215 translates to rotation of the first pulley 10. Similarly, a bottom end of the bearing shaft 215 of the second slide pivot assembly 300 includes a second pulley 11 that is fixedly attached thereto so that rotation of the shaft 215 translates to rotation of the second pulley 11. A first cable 20 has a first end fixedly attached to the first pulley 10 and a second end fixedly attached to the second pulley 11 (as by fasteners 15). A second cable 22 has a first end fixedly attached to the first pulley 10 and a second end fixedly attached to the second pulley 11 (as by fasteners 15). The attachment points to the pulleys 10, 11 is such that the first and second cables 20, 22 cross over one another (so as to resemble a FIG. 8 appearance) as shown. As shown in the side elevation view of FIG. 28, one cable 20, 22 is located above the other cable 20, 22 so that the two cables do not interfere with one another and contact one another. This arrangement of pulleys and cables provides the desired movements of assemblies 200, 300 described herein.

Wrist Flexion and Extension Training

When wrist flexion and extension training is desired, the left and right handles are placed in the upright (vertical) positions and the handle brackets 270 are locked in place. The user then places his or her forearms on the first and second forearm supports and the hands are supported on the assemblies 200, 300 and the user grasps the upright handles. Using the unaffected hand (wrist), wrist flexion and extension is performed resulting in the assembly 200, 300 pivoting and since the assemblies 200, 300 are operatively connected, the motion of the unaffected hand is mimicked by an identical or similar movement in the affected hand (wrist). In other words, the flexion and extension movements are observed in both wrists. The user is instructed to move both wrists in the same manner and at the same time. This behavior increases the potential for the user to activate any unaffected neural structures involving the wrist that remain intact on both sides of the brain.

Ulnar Deviation and Radial Deviation

When ulnar deviation and radial deviation training is desired, the left and right handles are placed in the horizontal positions and the handle brackets 270 are locked in place. The user then places his or her forearms on the first and second forearm supports and the hands are supported on the assemblies 200, 300 and the user grasps the horizontal handles. Using the unaffected hand (wrist), ulnar deviation and radial deviation is performed resulting in the assembly 200, 300 pivoting and since the assemblies 200, 300 are operatively connected, the motion of the unaffected hand is mimicked by an identical or similar movement in the affected hand (wrist). In other words, the ulnar deviation and radial deviation movements are observed in both wrists.

One of the advantages of the present wrist trainer 100 is that gravity does not adversely impact the exercises. In traditional devices, gravitational forces act against the hand (wrist) and can make it difficult to perform the exercises. The disclosed wrist trainer 100 is specifically constructed so that gravitational forces do not adversely impact the exercises since the assembly 200, 300 supports the hands/wrists of the user.

Thus, in accordance with the present disclosure, patients will place their wrists immediately in front of the arm (foam) pad which is the pivot point of a pulley that is mounted under the tabletop. The entire front part on which the hand grip is mounted will move horizontally parallel to the tabletop. Grasping the hand grip and moving at the wrist as shown will cause flexion and extension of their wrists. Two pulleys and linking cables mounted below the tabletop will cause the two hand grips to move in a mirrored manner.

Radial and ulnar deviation are produced by turning the hand grips 90 deg so they both point to the center and locking them in place. The patient will grasp the grips with palms down and thumbs in the middle. Now the patient will move parallel to the tabletop producing ulnar and radial deviation.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A convertible wrist rehabilitative training device for use with a stroke patient comprising:
a base;
a first slide pivot assembly that is pivotally mounted to the base, the first slide pivot assembly including a first wrist support that is associated with a first handle that is configured to move between a first handle position for use in wrist flexion and extension training and a second handle position for use in ulnar deviation and radial deviation training;
a second slide pivot assembly that is pivotally mounted to the base, the second slide pivot assembly a second wrist support that is associated with a second handle that is configured to move between a first handle position for use in wrist flexion and extension training and a second handle position for use in ulnar deviation and radial deviation training; and
a mechanism for operatively coupling the first wrist support with the second wrist support such that motion of one of the first wrist support and the second wrist support as a result of movement of an unaffected wrist on an unaffected hand by the user causes the other of the first wrist support and the second wrist support and an affected wrist on an affected hand to move in a symmetrical motion;
wherein in the first handle position, the first and second handles are oriented 90 degrees relative to the base and in the second handle position, the first and second handles are oriented parallel to the base.

2. The training device of claim 1, further including an adjustable first forearm support that is adjustably coupled to the base and position adjacent the first slide pivot assembly and an adjustable second forearm support that is adjustably coupled to the base and position adjacent the second slide pivot assembly.

3. The training device of claim 1, wherein the first slide pivot assembly includes a first bearing shaft that passes through a first hole formed in the base so that a bottom end of the first bearing shaft is exposed and is accessible along an underside of the base and wherein the second slide pivot assembly includes a second bearing shaft that passes through a second hole formed in the base so that a bottom end of the second bearing shaft is exposed and is accessible along the underside of the base.

4. The training device of claim 3, wherein the mechanism comprises a first pulley that is fixedly connected to the bottom end of the first bearing shaft; a second pulley that is fixedly connected to the bottom end of the second bearing shaft; and first and second cables coupled to the first and second pulleys.

5. The training device of claim 4, wherein a first end of the first cable is fixedly attached to the first pulley and a second end of the first cable is fixedly attached to the second pulley and a first end of the second cable is fixedly attached to the first pulley and a second end is fixedly attached to the second pulley, the first and second cables crossing over one another at a location between the first and second pulleys.

6. The training device of claim 1, wherein the base has a front edge and a rear edge and each of the first slide pivot assembly and the second slide pivot assembly is slidably movable across the base in a direction toward the front edge or the rear edge and can be locked in a set position.

7. The training device of claim 1, wherein each of the first slide pivot assembly and the second slide pivot assembly includes: an elongated wrist pivot support to which a bearing shaft is coupled; and a handle slide housing having an inner space in which the elongated wrist pivot support is disposed, whereby the handle slide housing is configured to slide along the elongated wrist pivot support in a direction toward or away from an inner edge of the base.

8. The training device of claim 7, wherein the bearing shaft is oriented at a 90 degree angle relative to the elongated wrist pivot support.

9. The training device of claim 7, further including a lock member to fix a position of the handle slide housing relative to the elongated wrist pivot support.

10. The training device of claim 7, wherein the handle slide housing includes a handle mount that is fixedly attached thereto and a handle bracket that is coupled to the handle mount and can be locked into a plurality of defined position relative to the handle mount including the first handle position and the second handle position.

11. The training device of claim 10, wherein the handle bracket of each of the first slide pivot assembly and the second slide pivot assembly includes a first side wall and a second side wall spaced from and parallel to the first side wall, wherein one of the first handle and second handle is attached to the first side wall.

12. The training device of claim 11, wherein the second side wall is pivotally attached to the handle mount and there is a lock mechanism to lock the handle bracket in a desired position relative to the handle mount.

13. The training device of claim 12, wherein the second side wall is pivotally coupled to the handle mount by a pivot shaft and the handle mount includes a locking holes that aligns with one of a plurality of locking holes formed through the second side wall and receives a locking fastener to lock the handle bracket in the desired position.

14. A convertible wrist rehabilitative training device for use with a stroke patient comprising:
a base table;
a first slide pivot assembly that is pivotally mounted to the base table, the first slide pivot assembly including a first handle that is configured to move between a first handle position for use in wrist flexion and extension training and a second handle position for use in ulnar deviation and radial deviation training;
a second slide pivot assembly that is pivotally mounted to the base, the second slide pivot assembly that includes a second handle that is configured to move between a first handle position for use in wrist flexion and extension training and a second handle position for use in ulnar deviation and radial deviation training; and
a pulley and cable mechanism for operatively coupling the first slide pivot assembly with the second slide pivot assembly such that motion of one of the first slide pivot assembly and the second slide pivot assembly as a result of movement of an unaffected wrist on an unaffected hand by the user causes the other of the first slide pivot assembly and the second slide pivot assembly and an affected wrist on an affected hand to move in a symmetrical motion, wherein the pulley and cable mechanism is disposed entirely along an underside of the base table.

15. The training device of claim 14, wherein the first slide pivot assembly includes a first bearing shaft that passes through a first hole formed in the base so that a bottom end of the first bearing shaft is exposed and is accessible along an underside of the base and wherein the second slide pivot assembly includes a second bearing shaft that passes through a second hole formed in the base so that a bottom end of the second bearing shaft is exposed and is accessible along the underside of the base, the first slide pivot assembly pivoting about an axis of the first bearing shaft and the second slide pivot assembly pivoting about an axis of the second bearing shaft.

16. The training device of claim 15, wherein the pulley and cable mechanism comprises a first pulley that is fixedly connected to the bottom end of the first bearing shaft; a second pulley that is fixedly connected to the bottom end of the second bearing shaft; and first and second cables coupled to the first and second pulleys.

17. The training device of claim 16, wherein a first end of the first cable is fixedly attached to the first pulley and a second end of the first cable is fixedly attached to the second pulley and a first end of the second cable is fixedly attached to the first pulley and a second end is fixedly attached to the second pulley, the first and second cables crossing over one another at a location between the first and second pulleys.

18. A convertible wrist rehabilitative training device for use with a stroke patient comprising:
a base;
a first slide pivot assembly that is pivotally mounted to the base, the first slide pivot assembly including a first adjustable handle bracket that supports a first handle, the first adjustable handle bracket being pivotally mounted to a handle mount and configured to move between a first handle position for use in wrist flexion and extension training and a second handle position for use in ulnar deviation and radial deviation training;
a second slide pivot assembly that is pivotally mounted to the base, the second slide pivot assembly a second adjustable handle bracket that supports a second handle, the second adjustable handle bracket being pivotally mounted to a handle mount and configured to move between a first handle position for use in wrist flexion and extension training and a second handle position for use in ulnar deviation and radial deviation training; and
a mechanism for operatively coupling the first wrist support with the second wrist support such that motion of one of the first wrist support and the second wrist support as a result of movement of an unaffected wrist on an unaffected hand by the user causes the other of the first wrist support and the second wrist support and an affected wrist on an affected hand to move in a symmetrical motion;
wherein in the first handle position, the first and second handles are oriented 90 degrees relative to the base and in the second handle position, the first and second handles are oriented parallel to the base.

19. The training device of claim 18, wherein the first slide pivot assembly includes a first bearing shaft that defines an axis about which the first slide pivot assembly pivots relative to the base and the second slide pivot assembly includes a second bearing shaft that defines an axis about which the second slide pivot assembly pivots relative to the base, the first and second bearing shafts passing through openings formed through the base to permit the first and second adjustable handle brackets to move in a sweeping action along a top surface of the base.

20. The training device of claim 19, wherein the mechanism is disposed entirely along an underside of the base and is coupled to the first and second bearing shafts, the pulley and cable mechanism comprising a first pulley that is fixedly connected to the bottom end of the first bearing shaft; a second pulley that is fixedly connected to the bottom end of the second bearing shaft; and first and second cables coupled to the first and second pulleys.
